(19) United States
(12) Patent Application Publication
(10) Pub. No.: US 2021/0022361 A1
(43) Pub. Date: Jan. 28, 2021

(54) OXIDATIVELY STABLE COMESTIBLES WITH TANNIC ACID AND METHODS OF MAKING THE SAME

(71) Applicant: Ajinomoto Health & Nutrition North America Inc., Itasca, IL (US)

(72) Inventors: Joseph A. FORMANEK, Itasca, IL (US); Kristof Van Belleghem, Wetteren (BE)

(73) Assignee: Ajinomoto Health & Nutrition North America Inc., Itasca, IL (US)

(21) Appl. No.: 16/936,479

(22) Filed: Jul. 23, 2020

Related U.S. Application Data
(60) Provisional application No. 62/877,673, filed on Jul. 23, 2019.

(51) Int. Cl. A23D 7/06; A23L 27/00; A23D 7/005; A23L 29/00; A23L 15/00; A23L 3/3544; A23L 27/60; C12J 1/00

(52) U.S. Cl. CPC A23D 7/06; A23L 27/82; A23D 7/0056; A23L 29/035; A23V 2002/00; A23L 15/00; A23L 3/3544; A23L 27/60; C12J 1/00; A23D 7/0053

(57) ABSTRACT

An oxidatively stable comestible that includes a comestible base containing an oil, an acidulant, and optionally an egg yolk or an egg yolk substitute, and up to 750 ppm of tannic acid blended into the comestible base, based on a total weight of the oxidatively stable comestible. A method of preparing the oxidatively stable comestible involving blending the tannic acid into an aqueous phase comprising the egg yolk or the egg yolk substitute to form a treated aqueous phase, adding the acidulant to the treated aqueous phase to form an acidified aqueous phase, and adding an oil phase comprising the oil into the acidified aqueous phase and blending.

### BACKGROUND OF THE INVENTION

### Field of the Invention

The present invention relates to oxidatively stable comestibles containing tannic acid and methods of making the same.

### Discussion of the Background

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Oil (lipid) oxidation is an undesired process that commonly occurs in oil containing food products. If allowed to progress freely, oil oxidation causes these food products to spoil and become unpleasing in flavor and/or appearance. It has been shown that oil oxidation is strongly catalyzed by free metal ions, such as iron and copper ions, for example, via Fenton processes.

Egg is a widely applied ingredient in the food industry, such as mayonnaise, where it provides flavor and functions as an emulsifier due to the presence of proteins and lecithin. However, the relatively high level of metal ions such as iron (˜3 mg iron) present in egg, and particularly in egg yolk, accelerates lipid oxidation and thus limits the shelf-life of such oil-containing products.

To counteract the oxidative nature of metal ions, chelating agents, such as ethylene diamine tetraacetic acid (EDTA) or its salts (e.g., calcium EDTA or disodium EDTA), are often used to prevent oil oxidation and spoilage. EDTA and its salts, however, are considered to be synthetic or artificial ingredients. Within the food industry, an increasing effort is being made to remove artificial ingredients and to replace them with natural alternatives. Owing to its effectiveness, reasonable cost, and lack of viable alternatives, however, EDTA has so far been one of the more difficult artificial ingredients to replace, with natural alternatives yielding disappointing results. For example, naturally produced siderophores (from yeast and fungi) are effective metal chelators, but unacceptably add color to foods and beverages.

Extracts or reductions obtained from botanical sources have been utilized to improve the oxidative stability of food products. However, typical extracts or reductions may only contain minor amounts of active components (e.g., as little as 2 percent or less), if these compounds are even known. Moreover, extracts or reductions generally contain a multitude of non-active components that impart an undesirable flavor, color, and/or texture to the food product.

In one example, rosemary extract possesses antioxidant properties; however, a rosemary extract incorporated into a food or beverage for its antioxidant properties also imparts a distinct rosemary taste, which is undesirable in most situations.

In another example, U.S. Pat. No. 9,949,501B2—incorporated herein by reference in its entirety, describes the use of reduced grape juice as an antioxidant in mayonnaise. However, the reduced grape juice adversely affects the coloration of the mayonnaise to an unacceptable degree, likely due to the multitude of inactive substances (impurities) which generate a very intense brownish color.

### SUMMARY OF THE INVENTION

In view of the forgoing, there is a need for natural antioxidants that can prevent the spoilage of comestibles, that are relatively free of non-effective compounds, and which do not adversely affect the organoleptic qualities of the food.

Accordingly, it is one object of the present invention to provide novel oxidatively stable comestibles containing natural antioxidants.

It is another object of the present disclosure to provide novel methods for making the oxidatively stable comestibles.

These and other objects, which will become apparent during the following detailed description, have been achieved by the inventors' discovery that tannic acid provides an excellent antioxidant effect to oil-containing comestibles, such as mayonnaise-based dressings, sauces, dips, and/or spreads, without adversely affecting the organoleptic properties (color, flavor, odor, and/or texture) of the comestible.

Thus, the present invention provides:

(1) An oxidatively stable comestible, comprising:

a comestible base comprising an oil and an acidulant; and

tannic acid blended into the comestible base;

wherein the tannic acid is present in an amount up to 750 ppm, based on a total weight of the oxidatively stable comestible.

(2) The oxidatively stable comestible of (1), wherein the tannic acid is present in an amount of 70 to 500 ppm, based on a total weight of the oxidatively stable comestible.

(3) The oxidatively stable comestible of (1) or (2), wherein the tannic acid is present in an amount of 100 to 450 ppm, based on a total weight of the oxidatively stable comestible.

(4) The oxidatively stable comestible of any one of (1) to (3), wherein the tannic acid blended into the comestible base is a purified form of tannic acid having a tannic acid content of at least 90 wt. %.

(5) The oxidatively stable comestible of any one of (1) to (4), wherein tannic acid is a polygalloyl glucose.

(6) The oxidatively stable comestible of any one of (1) to (4), wherein the tannic acid is a polygalloyl quinic acid ester.

(7) The oxidatively stable comestible of any one of (1) to (4), wherein tannic acid is a polygalloyl glucose having a weight average molecular weight of 1,260 to 1,600 g/mol, a polygalloyl glucose having a weight average molecular weight of 975 to 1,200 g/mol, or a polygalloyl quinic acid ester having a weight average molecular weight of 750 to 945 g/mol.

(8) The oxidatively stable comestible of any one of (1) to (7), which is substantially free of a phenolic acid.

(9) The oxidatively stable comestible of any one of (1) to (8), which is substantially free of gallic acid.

(10) The oxidatively stable comestible of any one of (1) to (9), which is substantially free of ethylene diamine tetraacetic acid.

(11) The oxidatively stable comestible of any one of (1) to (10), wherein the comestible base is a stable water-continuous emulsion.

(12) The oxidatively stable comestible of any one of (1) to (11), which is a dressing, a sauce, a dip, and/or a spread.

(13) The oxidatively stable comestible of any one of (1) to (12), which is a mayonnaise, a ranch dressing, a thousand island dressing, a creamy Italian dressing, a tartar sauce, or an aioli.

(14) The oxidatively stable comestible of any one of (1) to (13), wherein the oil is at least one selected from the group consisting of olive oil, vegetable oil, canola oil, soybean oil, corn oil, peanut oil, sunflower oil, sesame oil, coconut oil, and palm oil.

(15) The oxidatively stable comestible of any one of (1) to (14), wherein the acidulant is a vinegar, a citrus juice, or both.

(16) The oxidatively stable comestible of any one of (1) to (15), wherein the comestible base further comprises an egg yolk or an egg yolk substitute.

(17) The oxidatively stable comestible of any one of (1) to (16), wherein the comestible base further comprises at least one selected from the group consisting of a flavorant, a vegetable, a protein, a dairy product, a preservative, and a thickening agent.

(18) A method of preparing an oxidatively stable comestible comprising a) a comestible base comprising an oil, an acidulant, and an egg yolk or an egg yolk substitute, and b) tannic acid blended into the comestible base, wherein the tannic acid is present in an amount up to 750 ppm, based on a total weight of the oxidatively stable comestible, the method comprising:

blending the tannic acid into an aqueous phase comprising the egg yolk or the egg yolk substitute to form a treated aqueous phase;

adding the acidulant to the treated aqueous phase to form an acidified aqueous phase; and

adding an oil phase comprising the oil into the acidified aqueous phase and blending.

(19) The method of (18), wherein the treated aqueous phase has a pH of 5.5 to 7.5 and the acidified aqueous phase has a pH of 2.4 to 4.5.

(20) The method of (18) or (19), further comprising adding at least one selected from the group consisting of a flavorant, a vegetable, a protein, a dairy product, a preservative, and a thickening agent.

(21) The method of any one of (18) to (20), wherein the oxidatively stable comestible is a mayonnaise, a ranch dressing, a thousand island dressing, a creamy Italian dressing, a tartar sauce, or an aioli.

The foregoing paragraphs have been provided by way of general introduction, and are not intended to limit the scope of the following claims. The described embodiments, together with further advantages, will be best understood by reference to the following detailed description.

### DETAILED DESCRIPTION OF THE INVENTION

In the following description, it is understood that other embodiments may be utilized and structural and operational changes may be made without departure from the scope of the present embodiments disclosed herein.

### Definitions

As used herein, the phrase “substantially free”, unless otherwise specified, refers to a composition/material which contains less than 1 wt. %, preferably less than 0.5 wt. %, preferably less than 0.3 wt. %, preferably less than 0.2 wt. %, preferably less than 0.1 wt. %, preferably less than 0.05 wt. %, preferably less than 0.03 wt. %, preferably less than 0.02 wt. %, preferably less than 0.01 wt. %, preferably less than 0.001 wt. %, preferably less than 0.0001 wt. %, preferably 0 wt. % of a particular component, relative to a total weight of the composition/material.

As used herein, the terms “optional” or “optionally” means that the subsequently described event(s) can or cannot occur or the subsequently described component(s) may or may not be present (e.g., 0 wt %).

As used herein the phrase “oxidatively stable” refers to comestibles which are resistant to oxidation, in particular oil oxidation, and may be stored for prolonged periods of time without a significant degree of spoilage, rancidity, and/or discoloration.

### Oxidatively Stable Comestible

The present disclosure is directed to oxidatively stable comestibles prepared with tannic acid as a natural antioxidant (an EDTA replacement), which provides oil oxidation resistance over prolonged periods of storage without adversely affecting the organoleptic properties of the comestible.

Such oxidatively stable comestibles generally include the following: a) a comestible base comprising an oil, an acidulant, and optionally an egg yolk or an egg yolk substitute; and b) tannic acid.

### Tannic Acid

Tannic acid (hydrolyzable gallotannin), a specific type of tannin, is a mixture of polygalloyl glucoses or polygalloyl quinic acid esters with a number of galloyl units per molecule ranging from 2 to 12 (different degrees of esterification), depending on the plant source used to extract the tannic acid.

A wide range of tannic acids may be employed in the present disclosure, and may be extracted and/or isolated from various sources using techniques known to those of ordinary skill in the art. For example, the tannic acid may be obtained from plant sources including, but not limited to, Rhus chinensis, Rhus javanica, Rhus semialata, Rhus coriaria, Rhus potaninii, Rhus punjabensis var sinica (Diels) Rehder & E. H. Wilson, Quercus infectoria, Quercus cerris, Pseudotsuga menziesii, Caesalpinia spinosa, Fagus hayata Paiib. ex Hayata, Machilus thunbergii Sieb. & Zuc, Teri pods, Divi-Divi, Myrobalans, Dhava, and Mango. In particular, the tannic acid may be obtained from the pods, gall nuts (e.g., Chinese belly-shaped gallnuts, horned gallnuts, hard ensiform gallnuts, egg-hard ensiform gallnuts, and inflorescence gallnuts), or excrescences thereof from such plants.

In preferred embodiments, the tannic acid employed in the present disclosure is sourced from tara pods or husks from Caesalpinia spinosa, gall nuts (Aleppo gallnuts) of Quercus infectoria or excrescences thereof which form on the young branches of Quercus infectoria and belong to the species of Quercus L. (Fam. Fagaceae), or gallnuts (Chinese gallnuts) from Rhus semialata.

In some embodiments, the tannic acid is a polygalloyl glucose (made of glucose and gallic acid building blocks), preferably a polygalloyl glucose obtained from gall nuts (Aleppo gallnuts) of Quercus infectoria or gallnuts (Chinese gallnuts) from Rhus semialata. In some embodiments, the tannic acid is a polygalloyl quinic acid ester (made of quinic acid and gallic acid building blocks), preferably a polygalloyl quinic acid ester obtained from tara pods of Caesalpinia spinosa.

The tannic acid extract may be blended into the comestible base without purification. As such, the tannic acid used herein may be a relatively impure form of tannic acid, i.e., the tannic acid extract may contain less than 90 wt. %, or less than 85 wt. %, or less than 80 wt. %, or less than 75 wt. %, or less than 70 wt. % tannic acid relative to a total weight of the tannic acid extract (dry basis), along with considerable amounts (e.g., at least 10 wt. %, at least 15 wt. %, at least 20 wt. %, at least 25 wt. %, at least 30 wt. %, as a dry basis) of non-tannic acid components such as nucleic acids, proteins, lipids, carbohydrates or other materials naturally associated with the plant source.

Alternatively, the tannic acid extract may be subjected to one or more purification procedures to provide tannic acid in a purified form. Purification procedures may involve gel filtration, fractionation, partition separations, crystallization (including re-crystallization), chromatography (e.g., HPLC), and the like, or a combination thereof (for example as described in WO2017167168A1—incorporated herein by reference in its entirety).

In preferred embodiments, the tannic acid blended into the comestible base is a purified form of tannic acid having a tannic acid content of at least 90 wt. %, preferably at least 92 wt. %, preferably at least 94 wt. %, preferably at least 95 wt. %, preferably at least 96 wt. %, preferably at least 98 wt. %, preferably at least 99 wt. %, preferably at least 99.5 wt. %, preferably at least 99.9 wt. %, preferably at least 99.99 wt. % based on a total weight of the tannic acid material blended into the comestible base (dry basis). The purified form of tannic acid preferably has no more than 10 wt. %, preferably no more than 8 wt. %, preferably no more than 6 wt. %, preferably no more than 5 wt. %, preferably no more than 4 wt. %, preferably no more than 2 wt. %, preferably no more than 1 wt. %, preferably no more than 0.5 wt. %, preferably no more than 0.1 wt. %, preferably no more than 0.01 wt. %, preferably is completely free of components such as nucleic acids, proteins, lipids, carbohydrates or other materials naturally associated with the plant source. The tannic acid employed herein may contain various levels of gallic acid (non-esterified). In preferred embodiments, the tannic acid contains no more than 10 wt. %, preferably no more than 8 wt. %, preferably no more than 6 wt. %, preferably no more than 4 wt. %, preferably no more than 2 wt. %, preferably no more than 1 wt. %, preferably no more than 0.5 wt. % of gallic acid, based on a total weight of the tannic acid.

The tannic acid employed herein may be a mixture of tannic acids in terms of the number of galloyl moieties per tannic acid molecule, with the number of galloyl moieties ranging from at least 2, at least 3, at least 4, at least 5, at least 6, at least 7, and up to 12, up to 11, up to 10, up to 9, up to 8 galloyl moieties per tannic acid molecule (based on glucose or quinic acid). In some embodiments, the total amount of tannic acids having 3 or less galloyl moieties per molecule may be less than 15 wt. %, preferably less than 10 wt. %, preferably less than 5 wt. %, preferably less than 1 wt. %, preferably 0 wt. %, based on a total tannic acid content in the mixture. In some embodiments, the total amount of tannic acids having 10 or more galloyl moieties per molecule may be less than 15 wt. %, preferably less than 10 wt. %, preferably less than 5 wt. %, preferably less than 1 wt. %, preferably 0 wt. %, based on a total tannic acid content in the mixture. In some embodiments, the total amount of tannic acids having 4 to 9 galloyl moieties per molecule may be at least 80 wt. %, preferably at least 85 wt. %, preferably at least 90 wt. %, preferably at least 95 wt. %, preferably at least 99 wt. %, based on a total tannic acid content in the mixture.

The tannic acid employed herein may be generally categorized into the following categories based on the distribution of galloyl moieties: high molecular weight (1,260 to 2,020 g/mol), medium molecular weight (950 to <1,260 g/mol), or low molecular weight (485 to <950 g/mol), each in terms of weight average molecular weight. In some embodiments, the tannic acid is a high molecular weight tannic acid (e.g., polygalloyl glucose), preferably having a weight average molecular weight of at least 1,260 g/mol, preferably at least 1,300 g/mol, preferably at least 1,350 g/mol, preferably at least 1,400 g/mol, preferably at least 1,140 g/mol, and up to 1,600 g/mol, preferably up to 1,550 g/mol, preferably up to 1,500 g/mol, preferably up to 1,450 g/mol. In some embodiments, the tannic acid is a medium molecular weight tannic acid (e.g., polygalloyl glucose), preferably having a weight average molecular weight of at least 975 g/mol, preferably at least 1,000 g/mol, preferably at least 1,020 g/mol, preferably at least 1,040 g/mol, and up to 1,200 g/mol, preferably up to 1,150 g/mol, preferably up to 1,100 g/mol, preferably up to 1,060 g/mol. In some embodiments, the tannic acid is a low molecular weight tannic acid (e.g., polygalloyl quinic acid ester), preferably having a weight average molecular weight of at least 750 g/mol, preferably at least 780 g/mol, preferably at least 800 g/mol, preferably at least 820 g/mol, preferably at least 840 g/mol, and up to 945 g/mol, preferably up to 920 g/mol, preferably up to 900 g/mol, preferably up to 880 g/mol, preferably up to 860 g/mol.

The tannic acid may be a heterogeneous mixture in terms of the distribution of numbers of galloyl moieties per tannic acid molecule, i.e., the tannic acid has a wide range of galloyl moieties within the tannic acid population, where no more than 85% by weight of the tannic acid population is made up of any one or two tannic acid compounds in terms of the number of galloyl moieties per molecule.

Alternatively, the tannic acid blended into the comestible base may be homogeneous, i.e., the tannic acid has a narrow distribution of galloyl moieties within the tannic acid population, where at least 85%, preferably at least 90%, preferably at least 92%, preferably at least 94%, preferably at least 96%, preferably at least 98% by weight of a total tannic acid population is defined by any one or two tannic acid compounds in terms of the number of galloyl moieties per molecule.

For example, the tannic acid utilized herein may be tannic acid containing 4 and/or 5 galloyl moieties per molecule (e.g., one or more of tetragalloyl- and pentagalloyl-quinic acid ester) in an amount(s) of at least 85 wt. % relative to a total tannic acid population, and which contains less than 15 wt. % of tannic acids containing 2, 3, and 6 to 12 galloyl moieties per molecule combined.

In another example, the tannic acid utilized herein may be tannic acid containing 6 and/or 7 galloyl moieties per molecule (e.g., one or more of hexagalloyl- and heptagalloyl-glucose) in an amount(s) of at least 85 wt. % relative to a total tannic acid population, and which contains less than 15 wt. % of tannic acids containing 2 to 5 and 8 to 12 galloyl moieties per molecule combined.

In yet another example, the tannic acid utilized may be tannic acid containing 8 and/or 9 galloyl moieties per molecule (e.g., one or more of octagalloyl- and nonagalloyl-glucose) in an amount(s) of at least 85 wt. % relative to a total tannic acid population, and which contains less than 15 wt. % of tannic acids containing 2 to 7 and 10 to 12 galloyl moieties per molecule combined.

In some embodiments, the tannic acid employed herein is a single compound in terms of the number of galloyl moieties per molecule, having only 2, 3, 4, 5, 6, 7, 8, 9, 10, 11 or 12 galloyl moieties per molecule.

Specific examples of the tannic acid that may be employed herein, include, but are not limited to TANAL/ALSOK 01, which is a high molecular weight (avg. Mw of 1440 g/mol) tannic acid obtained from Rims semialata (Chinese Gallnut) formed from gallic acid/glucose building blocks having a minimum tannic acid content of 98%; TANAL/ALSOK 02, which is a medium molecular weight (avg. Mw of 1,040 g/mol) tannic acid obtained from Quercus infectoria (Aleppo Gallnut) formed from gallic acid/glucose building blocks having a minimum tannic acid content of 96%; and TANAL/ALSOK 04, which is a low molecular weight (avg. Mw of 860 g/mol) tannic acid obtained from Caesalpinia spinosa (Tara Pods) formed from gallic acid/quinic acid building blocks having a minimum tannic acid content of 96%, each commercially available from Ajinomoto Bio-Pharma services.

Tannic acid may be blended, mixed, or otherwise uniformly distributed into the comestible base of the present disclosure in any amount that provides an antioxidant effect. Typically, tannic acid is employed in amounts anywhere up to 750 ppm, based on a total weight of the oxidatively stable comestible, for example, anywhere from 30 ppm, preferably from 40 ppm, preferably from 50 ppm, preferably from 60 ppm, preferably from 70 ppm, preferably from 80 ppm, preferably from 90 ppm, preferably from 100 ppm, preferably from 150 ppm, preferably from 200 ppm, and up to 750 ppm, preferably up to 700 ppm, preferably up to 650 ppm, preferably up to 600 ppm, preferably up to 550 ppm, preferably up to 500 ppm, preferably up to 450 ppm, preferably up to 400 ppm, preferably up to 350 ppm, preferably up to 300 ppm, preferably up to 250 ppm, based on a total weight of the oxidatively stable comestible.

The above dosages of tannic acid have been generally found to provide a desirable balance between providing an antioxidant effect while not significantly affecting the organoleptic properties of the comestible. In some applications, such as in mayonnaise or ranch dressing, dosages higher than 500 ppm begin to cause some taste and/or color changes, which may not be desirable. However, it should be noted that tannic acid dosages exceeding 500 ppm, and even exceeding 750 ppm, may be acceptable in some cases, for example when used in comestibles traditionally having high color and/or full flavor profiles.

The tannic acid may be blended into the comestible base as a solid (e.g., powder) or as an aqueous solution, preferably as an aqueous solution. The weight percent of the tannic acid in the aqueous solution may be up to 50 wt. %, preferably up to 30 wt. %, preferably up to 10 wt. %, preferably up to 5 wt. %, preferably up to 1 wt. %, preferably up to 0.5 wt. %, preferably up to 0.4 wt. %, preferably up to 0.1 wt. %, preferably up to 0.075 wt. %, preferably up to 0.05 wt. %, preferably up to 0.03 wt. %, preferably up to 0.02 wt. %, preferably up to 0.01 wt. %, preferably up to 0.007 wt. %, based on a total weight of the aqueous solution. Accordingly, an amount of the aqueous solution sufficient to provide the above ppm concentrations of tannic acid may be added. When purified tannic acid is formulated as an aqueous solution, the aqueous solution preferably contains no more than 5 wt. %, preferably no more than 4 wt. %, preferably no more than 2 wt. %, preferably no more than 1 wt. %, preferably no more than 0.5 wt. %, preferably no more than 0.1 wt. %, preferably no more than 0.01 wt. %, preferably is completely free (0 wt. %) of components naturally associated with the plant source from which the tannic acid is isolated and purified.

Not wishing to be limited by theory, it is believed that the tannic acid chelates/binds to pro-oxidative material (i.e., metal ions) in the comestible base, thereby acting as an antioxidant and protecting against, minimizing, reducing, and/or preventing the oxidation of oils present therein. As a result, the oxidatively stable comestible has an extended shelf life and can be kept for prolonged periods of time (e.g., up to 7 months), even under elevated temperature conditions (e.g., up to 40° C.) without spoilage or developing poor organoleptic properties such as unpleasant taste or dark discoloration. In particular, tannic acid has been found to provide superior results, in terms of antioxidant effects and also in terms of not adversely effecting organoleptic properties of the comestible, compared to other natural antioxidants, for example, gallic acid, which introduces an astringent and sour character. Tannic acid can thus be used to take the place of synthetic antioxidant materials such as ethylene diamine tetraacetic acid (EDTA) and its salt variants.

Other antioxidants may optionally be included in the oxidatively stable comestible (in addition to tannic acid), in amounts as described above for tannic acid, for example, those based on polyphenols (tannins, flavonoids, phenolic acids, etc.), aminopolycarboxylic acids, organic hydroxy acids, and the like. Examples of other antioxidants include, but not limited to,
tannins (other than tannic acid described heretofore), including condensed tannins, phlorotannins, ellagitannins, proanthocyanidins, oligostilbenoids, as well as combinations thereof;
flavonoids such as anthocyanidins (e.g., cyanidin, delphinidin, malvidin, pelargonidin, peonidin, petunidin), anthocyanins (glycosides of anthocyanidins), flavonols (e.g., galangin, kaempferide, myricetin, quercetin), flavones (e.g., apigenin, baicalein, chrysin, diosmetin), isoflavones (e.g., daidzein, genistein), flavanones (e.g., eriodictyol, hesperidin, naringenin, silymarin), catechins (e.g., (+)-catechin, (+)-gallocatechin, (−)-epicatechin), chalcones (e.g., xanthohumol and dehydro-cycloxanthohumol hydrate), stilbenes (e.g., resveratrol), lignans (e.g., secoisolariciresinol), as well as combinations thereof,
phenolic acids such as hydroxycinnamic acids (e.g., p-coumaric acid, caffeic acid, feluric acid, chlorogenic acid, sinapic acid) and hydroxyl benzoic acid (e.g., 4-hydroxy benzoic acid, gallic acid, protocatechuic acid, syringic acid, vanillic acid), as well as combinations thereof
aminopolycarboxylic acids such as ethylene diamine tetraacetic acid (EDTA), diethylene triamine pentaacetic acid (DPTA), hydroxyethylene diamine triacetic acid (HEDTA), ethylene diamine di-ortho-hydroxy-phenyl acetic acid (EDDHA), ethylene diamine di-ortho-hydroxy-para-ethyl phenyl acetic acid (EDDHMA), ethylene diamine di-ortho-hydroxy-para-carboxy-phenyl acetic acid (EDDCHA), nitrolotriacetic acid (NTA), as well as the sodium, potassium, and/or ammonium salts thereof, and combinations thereof including mono-salts, di-salts, etc. thereof;
organic hydroxy acids such as citric acid, tartaric acid, and malic acid, and combinations thereof;
as well as combinations thereof.

In some embodiments, the oxidatively stable comestible is substantially free of other antioxidants (i.e., antioxidants other than tannic acid). In some embodiments, the oxidatively stable comestible is substantially free of phenolic acids, in particular gallic acid. In some embodiments, the oxidatively stable comestible is substantially free of grape juice or components found in grape extracts, such as grape seed extracts. In some embodiments, the oxidatively stable comestible is substantially free of flavonoids and/or phenolic acids found in balsamic vinegar, reduced grape juice, and/or must, for example as described in U.S. Pat. No. 9,949,501—incorporated herein by reference in its entirety. In some embodiments, the oxidatively stable comestible is substantially free of aminopolycarboxylic acids, in particular EDTA and its salts. In embodiments where EDTA, including salts forms, is not present, the comestible may be described as EDTA-free.

### Comestible Base

As described above, tannic acid is useful for preventing or minimizing oil oxidation and may thus be used in any comestible base that contains oil. In some embodiments, the comestible base is an emulsion, preferably a stable emulsion, more preferably a stable water-continuous emulsion.

One of the benefits of the present disclosure is that advantageous oxidative stability may be realized in numerous comestible bases having varying oil content. The comestible base may contain at least 5 wt %, preferably at least 10 wt %, preferably at least 20 wt. %, preferably at least 30 wt. %, preferably at least 40 wt. %, preferably at least 50 wt. %, preferably at least 55 wt. %, and up to 85 wt. %, preferably up to 80 wt. %, preferably up to 75 wt. %, preferably up to 70 wt. %, preferably up to 65 wt. %, preferably up to 60 wt. % of an oil phase, and at least 15 wt. %, preferably at least 20 wt. %, preferably at least 25 wt. %, preferably at least 30 wt. %, preferably at least 35 wt. %, preferably at least 40 wt. %, preferably at least 45 wt. %, preferably at least 50 wt. %, and up to 95 wt. %, preferably up to 90 wt. %, preferably up to 85 wt. %, preferably up to 80 wt. %, preferably up to 75 wt. %, preferably up to 70 wt. %, preferably up to 65 wt. %, preferably up to 60 wt. %, preferably up to 55 wt. % of an aqueous phase, each based on a total weight of the comestible base.

The oxidatively stable comestible may be a dressing, a sauce, a dip, and/or a spread, may have a texture range from light creamy to thick, and may be spoonable, spreadable, and/or pourable. In preferred embodiments, the oxidatively stable comestible is a mayonnaise-based dressing, sauce, dip, and/or spread. In some embodiments, the oxidatively stable comestible is a mayonnaise. The mayonnaise may, but does not need to, conform to the Food and Drug Administration's regulations 21 C.F.R. § 169.140 regarding the contents of mayonnaise. Mayonnaise is generally known as a thick, creamy sauce that can be used as a condiment with other foods. Mayonnaise may vary in color, but is generally white, cream-colored, or pale yellow.

The comestible base of the present disclosure generally includes an oil, an acidulant, and optionally an egg yolk (or an egg yolk substitute).

### Egg Yolk

Egg yolk (or an egg yolk substitute) may be present in the comestible base in an amount from at least 0.5 wt %, preferably at least 1 wt %, preferably at least 2 wt %, preferably at least 3 wt. %, preferably at least 4 wt. %, preferably at least 5 wt. %, preferably at least 6 wt. %, and up to 15 wt. %, preferably up to 13 wt. %, preferably up to 11 wt. %, preferably up to 10 wt. %, preferably up to 9 wt. %, preferably up to 8 wt. %, preferably up to 7 wt. %, based on a total weight of the oxidatively stable comestible. When egg yolk is present in the comestible base, the weight percentage refers to ordinary ‘wet’ egg yolk (optionally pasteurized).

Of course, it should be understood that the disclosure also encompasses the use of egg yolk substitutes. An egg yolk substitute refers to any ingredient(s) that takes the place of traditional (‘wet’) egg yolk that provides at least some of the function/properties (e.g., emulsification, consistency, etc.) of traditional egg yolk. An egg yolk substitute may be a traditional egg yolk which has been modified in some way (“modified egg yolks”) or an ingredient that is substantially free of, and is not derived from, traditional egg yolk (“egg yolk replacements”).

Modified egg yolk may include enzyme modified egg yolks, lyophilized (powdered) egg yolks, or egg yolks which are fortified with additional emulsifiers.

Enzyme modified egg yolk refers to egg yolks treated with enzymes so as to improve some function or property of the egg yolk, for example, to increase the emulsifying capacity of the egg yolk. Suitable enzyme modified egg yolks include those modified with phospholipases such as phospholipase A. Phospholipases are a family of enzymes which hydrolyze carboxylic ester bonds within phospholipids. The treatment of phospholipids with enzymes, such as phospholipase, results in emulsions having superior stability, and in particular superior heat stability. One non-limiting example of an enzyme modified egg yolk is EMULSA available from Michael Foods, although many other types of enzyme modified egg products intended for use in emulsions may be used herein.

In some embodiments, it may be desirable to use egg yolks which are fortified with additional emulsifiers. The amount of the emulsifier preferably ranges from at least 0.001 wt %, preferably at least 0.01 wt. %, preferably at least 0.1 wt. %, preferably at least 0.5 wt. %, and up to 2 wt. %, preferably up to 1.5 wt. %, preferably up to 1 wt. % by weight of the oxidatively stable comestible. Such emulsifiers may include, but are not limited to, polysorbates such as polyoxyethylene sorbitan monolaurate, polyoxyethylene sorbitan monopalmitate, polyoxyethylene sorbitan monostearate, polyoxyethylene sorbitan monooleate, and sorbitan tristearate; phospholipids, including those with a sphingosine backbone or a glycerol backbone (phosphoglycerides), with specific mention to phosphatidic acid, phosphatidylethanolamine, phosphatidylcholine, phosphatidylserine, phosphatidylinositol, phosphatidylinositol phosphate, phosphatidylinositol bisphosphate, phosphatidylinositol triphosphate, ceramide phosphoryl choline, ceramide phosphorylethanolamine and ceramide phosphoryl glycerol; casein; albumin; glycerol monostearate; as well as combinations thereof. In preferred embodiments, when utilized, the emulsifier is phosphatidylcholine (lecithin) sourced from non-animal products such as soybean, mustard, sunflower, and the like, examples of which include, but are not limited to, YELKIN, ULTRALEC, BEAKIN, PERFORMIX, and THERMOLEC each available from Archer Daniels Midland.

In some embodiments, it may be desirable to replace egg yolk with an egg yolk replacement, for example, to provide comestibles for those allergic to eggs, those on a vegan diet, or to minimize metal ion content in the comestible base to further limit oil oxidation. It is contemplated that any egg yolk replacement known to those of ordinary skill may be used in the present disclosure, with specific mention made to egg whites, certain oils such as coconut oil, and those made from starch, e.g., ENER-G EGG REPLACER from Ener-G and NO EGG Egg replacer from Orgran, which contain potato starch, tapioca starch and leavening agents. Egg yolk replacements may also be utilized which are rich in emulsifiers, such as those described above, to mimic the emulsifying properties of the proteins and lecithin present in egg yolk.

### Acidulant

An acidulant may be incorporated into the comestible base in an amount sufficient to provide the comestible base with a pH of at least 2.4, preferably at least 2.6, preferably at least 2.8, preferably at least 3.0, preferably at least 3.2, preferably at least 3.4, preferably at least 3.8, and up to 5.0, preferably up to 4.8, preferably up to 4.5, preferably up to 4.4, preferably up to 4.3, preferably up to 4.2, preferably up to 4.1, preferably up to 4.0, preferably up to 3.9. The acidulant is typically present in the comestible base in an amount from at least 0.1 wt. %, preferably at least 0.5 wt. %, preferably at least 1 wt. %, preferably at least 1.5 wt. %, preferably at least 2 wt. %, preferably at least 2.5 wt. %, preferably at least 3 wt. %, preferably at least 3.5 wt. %, preferably at least 4 wt. %, preferably at least 4.5 wt. %, preferably at least 5 wt. %, and up to 10 wt. %, preferably up to 9 wt. %, preferably up to 8 wt. %, preferably up to 7 wt %, preferably up to 6 wt %, preferably up to 5.5 wt %, based on a total weight of the oxidatively stable comestible.

The acidulant may be a vinegar, a citrus juice (e.g., a juice from lemons, oranges, grapefruits, limes, and/or tangerines), a phosphoric acid, a bisulfate (e.g., sodium bisulfate), lactic acid, and the like, as well as mixtures thereof.

In preferred embodiments, the acidulant is a vinegar. The vinegar may be sourced from fruits, grains, alcoholic beverages, as well as various other fermentable materials. Exemplary vinegars which may be employed as the acidulant herein, include, but are not limited to, wine vinegar, sherry vinegar, spirit vinegar, white vinegar, rice vinegar, apple vinegar, malt vinegar and combinations thereof. The vinegar is typically an aqueous solution containing at least 0.5 wt. %, preferably at least 1 wt. %, preferably at least 2 wt. %, preferably at least 3 wt. %, preferably at least 4 wt. %, preferably at least 5 wt. %, preferably at least 5 wt. %, preferably at least 8 wt. %, preferably at least 10 wt. % acetic acid, and up to 20 wt. %, preferably up to 18 wt. %, preferably up to 16 wt. %, preferably up to 14 wt. %, preferably up to 12 wt. % acetic acid, based on a total weight of the vinegar. While the acetic acid content of the vinegar typically does not exceed 20 wt. %, the use of vinegars with higher acetic acid contents, for example up to 60 wt. %, as well as the use glacial acetic acid, are also contemplated herein.

In preferred embodiments, the acidulant (e.g., vinegar) contains less than 15 wt. %, preferably less than 10 wt. %, preferably less than 5 wt. %, preferably less than 2 wt. %, preferably less than 1 wt. %, preferably less than 0.5 wt. %, preferably 0 wt. % of sugars (e.g., monosaccharides such as fructose and glucose, and disaccharides such as sucrose) by weight of dry matter.

### Oil

That comestible base may also include any oil which is edible. The oil(s) may include one or more lipids including, but not limited to, triglycerides, diglycerides, monoglycerides, and free fatty acids, including both saturated and unsaturated (e.g., monounsaturated, polyunsaturated) variants thereof. Typically, oils are utilized which are liquid at ambient temperature, however, oils which are partially or wholly solid at ambient temperature may also be used.

The oil may be derived from plant sources or animal sources, preferably the oil is a plant-based oil. Suitable oils which may be utilized in the present disclosure include, but are not limited to, olive oil, vegetable oil, canola oil, soybean oil, corn oil, jojoba oil, coconut oil, peanut oil, sunflower oil, sesame oil, palm oil, rice germ oil (rice bran oil), safflower oil, cottonseed oil, lard oil, fish oil, castor oil, or any other oil known in the art, as well as mixtures thereof. In preferred embodiments, the oil is soybean oil.

In some embodiments, the oil is present in an amount of at least 5 wt. %, preferably at least 10 wt. %, preferably at least 20 wt. %, preferably at least 30 wt. %, preferably at least 40 wt. %, preferably at least 45 wt. %, preferably at least 50 wt. %, preferably at least 55 wt. %, and up to 85 wt %, preferably up to 80 wt %, preferably up to 76 wt %, preferably up to 75 wt. %, preferably up to 70 wt. %, preferably up to 65 wt. %, preferably up to 60 wt. %, based on a total weight of the oxidatively stable comestible.

### Optional Ingredients

Many other ingredients can optionally be added to the comestible base, for example, to form a flavored mayonnaise such as chipotle mayonnaise, or any other dressing, sauce, dip, and/or spread that is mayonnaise-based, including, but not limited to, a ranch dressing, a thousand island dressing, a creamy Italian dressing, a tartar sauce, an aioli, a fry sauce, a Marie Rose sauce, a rouille sauce, a salsa golf sauce, and a sauce remoulade.

For example, one or more of a flavorant, a vegetable, a protein, a dairy product, a preservative, and a thickening agent may be optionally added to the comestible base, as desired.

Flavorants may include various herbs, spices, powders, encapsulated flavorants, flavored oils, or any other ingredient that is added to modify or balance the flavor profile of the comestible base. Exemplary flavorants include, but are not limited to, oregano, basil, parsley, chives, salt (e.g., sodium chloride, calcium chloride, potassium chloride, magnesium chloride, sulfate salts of calcium, potassium, and magnesium, and mixtures thereof such as sea salt, and those mixed with iodine salts, i.e., iodized salt), pepper, mustard, coriander, curry, chili powder, chili sauce, close, lavender, rosemary, chervil, anise seed, garlic, cilantro, horseradish, fennel seed, bay leaves, caraway seeds, celery seed, allspice, nutmeg, paprika, thyme, tarragon, turmeric, dill, sage, saffron, poppy seed, sesame seed, marjoram, mint, cayenne pepper, red/green pepper, mace, chipotle, cinnamon, fenugreek, ginger, wasabi, monosodium glutamate (MSG), sugars (e.g., monosaccharides such as one or more of fructose and glucose, disaccharides such as sucrose) or other sweeteners (e.g., brown sugar, molasses, corn syrup, high fructose corn syrup, light corn syrup, dark corn syrup, maltodextrins, corn sweetener, artificial sweeteners), ketchup, TABASCO sauce available from McIlhenny Co. or other hot sauce sourced from peppers, soy sauce, brandy, dairy flavors or any other spice flavors, including combinations thereof. The flavorant(s) may be added in any amount needed to alter and/or enhance the flavor of the oxidatively stable comestible. When present, the oxidatively stable comestible typically contains up to 10 wt. %, preferably up to 8 wt. %, preferably up to 6 wt. %, preferably up to 5 wt. %, preferably up to 4 wt. %, preferably up to 3 wt. %, preferably up to 2 wt. %, preferably up to 1 wt. %, preferably up to 0.5 wt. % of the flavorant(s), based on a total weight of the oxidatively stable comestible.

Vegetables may also optionally be added to flavor and/or add texture to the comestible base. The vegetables can be included as small pieces, flakes, powders, and/or purees. The vegetables can be added as dried vegetables, pickled vegetables, such as relish, and/or fresh vegetables. Examples of vegetables include, but are not limited to, tomato, potato, carrot, turnip, spinach, lettuce, onion, pepper, celery, parsnip, asparagus, eggplant, bok choy, brussel sprouts, cabbage, corn, pumpkin, cucumber, squash, peas, beets, broccoli, gherkins/pickles, capers, and combinations thereof. When present, the oxidatively stable comestible typically contains up to 10 wt. %, preferably up to 8 wt. %, preferably up to 6 wt. %, preferably up to 5 wt. %, preferably up to 4 wt. %, preferably up to 3 wt. %, preferably up to 2 wt. %, preferably up to 1 wt. %, preferably up to 0.5 wt. % of the vegetable(s), based on a total weight of the oxidatively stable comestible.

Proteins may be optionally added to the comestible base to alter the flavor profile or to add texture to the comestible base. Additionally, proteins may be optionally added to promote or enhance the formation of an oil/water emulsion. Proteins may be in the form of bits, pieces, chunks, strips, and/or powders. The proteins may be vegetable proteins such as soy, animal proteins such as fish (e.g., anchovy), shellfish, beef, turkey, chicken, pork (e.g., bacon), lamb, bison, dairy, whey, egg, as well as legume proteins, and the like, including combinations thereof. When utilized, the proteins may be added to the comestible base in any amount sufficient to provide desirable flavor and/or texture and/or emulsification properties to the comestible base, typically in amounts of up to 6 wt. %, preferably up to 5 wt. %, preferably up to 4 wt. %, preferably up to 3 wt. %, preferably up to 2 wt. %, preferably up to 1 wt. %, preferably up to 0.5 wt. %, based on a total weight of the oxidatively stable comestible.

The comestible base may also optionally include at least one dairy product. Suitable dairy products include, but are not limited to, whole buttermilk, skim buttermilk, whole milk, 2% milk, 1% milk, skim milk, sour cream, yogurt, and combinations thereof, any of which may be in either fresh or dehydrated forms. Such dairy products may be optionally added to make a comestible base such as a ranch dressing (e.g., using whole buttermilk) that typically includes such ingredients. When present, the oxidatively stable comestible typically contains up to 35 wt. %, preferably up to 30 wt. %, preferably up to 25 wt. %, preferably up to 20 wt. %, preferably up to 15 wt. %, preferably up to 10 wt. %, preferably up to 5 wt. %, preferably up to 1 wt. %, preferably up to 0.5 wt. % of the dairy product, based on a total weight of the oxidatively stable comestible.

Preservatives may be optionally included in the comestible base of the present disclosure, to prevent the growth of mold, the growth of bacteria, degradation or chemical breakdown, etc. so as to keep the comestible fresh for longer periods of time. Preservatives suitable for use in food are well-known to those skilled in the art. Illustrative examples include, but are not limited to, benzoates (e.g., sodium benzoate, benzoic acid), sorbates (e.g., sorbic acid, sodium sorbate, potassium sorbate, calcium sorbate), propionates (e.g., propionic acid), ascorbates (e.g., ascorbic acid, sodium ascorbate) including stereoisomers thereof (e.g., erythorbic acid, sodium erythorbate), rosemary extract, alpha-tocopherol (vitamin E), kojic acid, and mixtures thereof. Preferably, the preservative is a combination of potassium sorbate and sodium benzoate. When present, the preservative(s) may be optionally included in the comestible base in amounts from 0.001 wt. %, preferably from 0.01 wt. %, preferably from 0.06 wt. %, preferably from 0.1 wt. %, and up to 2 wt. %, preferably up to 1 wt. %, preferably up to 0.5 wt. %, based on a total weight of the oxidatively stable comestible.

Any suitable food-grade thickening agent known to those of ordinary skill in the art may optionally be included in the comestible base. When present, the thickening agent may be present in amounts of at least 0.001 wt. %, preferably at least 0.01 wt. %, preferably at least 0.02 wt. %, preferably at least 0.05 wt. %, preferably at least 0.1 wt. %, and up to 1 wt. %, preferably up to 0.5 wt. %, preferably up to 0.4 wt. %, preferably up to 0.3 wt. %, preferably up to 0.2 wt. %, preferably up to 0.15 wt. %, based on a total weight of the oxidatively stable comestible. Acceptable examples of such thickening agents include, but are not limited to, starch and gums such as xanthan gum, guar gum, carrageenan, salts of alginic acid (e.g., sodium alginate, potassium alginate, ammonium alginate, and/or calcium alginate), locust bean gum, agar, tapioca, gelatin, pectin, gum arabic (acacia), inulin, propylene glycol alginates, including mixtures or blends of gums such as CARAGUM available from TIC gums; modified starch such as cold-water swellable and cold water soluble starches derived from waxy maize or tapioca (e.g., ULTRASPERSE M, ULTRASPERSE SR, and INSTANT TEXTRA, each available from Ingredion); modified cellulose polymers such as hydroxypropylmethylcellulose (HPMC), methylcellulose (MC), and carboxymethylcellulose (CMC); as well as mixtures thereof. Preferably, when employed, the thickening agent is xanthan gum.

### Properties

The ability of tannic acid to prevent oil oxidation may be assessed by measuring the development in lipid oxidation products using one or more of Thiobarbituric acid-reactive substances (TBARS) assay, peroxide value (PV) assay, and volatile (headspace) analysis via GC/MS.

In some embodiments, the oxidatively stable comestible of the present disclosure has a TBARS value (expressed as mg of MAD equivalents/kg sample×10) of from 50, preferably from 75, preferably from 100, preferably from 125, preferably from 150, and up to 260, preferably up to 255, preferably up to 250, preferably up to 240, preferably up to 230, preferably up to 220, preferably up to 210, preferably up to 200, preferably up to 190, preferably up to 180, preferably up to 170, preferably up to 160, after being subjected to a standard shelf life test at room temperature (23° C.±2° C.) for 13 weeks according to the TBARS procedure described in Example 1. In some embodiments, the oxidatively stable comestible of the present disclosure has a TBARS value (expressed as mg of MAD equivalents/kg sample×10) of from 20, preferably from 30, preferably from 40, preferably from 50, preferably from 60, and up to 105, preferably up to 102, preferably up to 100, preferably up to 95, preferably up to 90, preferably up to 85, preferably up to 80, preferably up to 75, preferably up to 70, preferably up to 65, after being subjected to an accelerated shelf life test at 40° C. for 8 weeks according to the TBARS procedure described in Example 1.

In some embodiments, the oxidatively stable comestible of the present disclosure has a PV value (expressed as absorbance) of from 1.0, preferably from 1.5, preferably from 1.6, preferably from 1.7, and up to 2.2, preferably up to 2.1, preferably up to 2.0, preferably up to 1.9, preferably up to 1.85, preferably up to 1.8, preferably up to 1.75, after being subjected to a standard shelf life test at room temperature (23° C.±2° C.) for 13 weeks according to the PV assay procedure described in Example 1. In some embodiments, the oxidatively stable comestible of the present disclosure has a PV value (expressed as absorbance) of from 0.01, preferably from 0.05, preferably from 0.07, preferably from 0.08, and up to 0.29, preferably up to 0.28, preferably up to 0.26, preferably up to 0.24, preferably up to 0.22, preferably up to 0.2, preferably up to 0.18, preferably up to 0.16, preferably up to 0.14, preferably up to 0.12, after being subjected to an accelerated shelf life test at 40° C. for 8 weeks according to the PV assay procedure described in Example 1.

The ability of tannic acid to prevent oil oxidation without adversely affecting the organoleptic properties of the comestible base to which it is added may be assessed by the organoleptic flavor and color analysis described in Examples 1 and 3.

In some embodiments, the oxidatively stable comestible has an organoleptic flavor score (0-7) of at least 4.25, preferably at least 4.5, preferably at least 4.75, preferably at least 5.0, preferably at least 5.25, preferably at least 5.5, preferably at least 5.75, preferably at least 6.0, preferably at least 6.25, preferably at least 6.5, preferably at least 6.75, and up to 7, when subjected to a standard shelf life test (25° C.) for up to 7 months.

In some embodiments, the oxidatively stable comestible has an organoleptic color score (0-7) of 4 or less, preferably 3 or less, preferably 2 or less, preferably 1 or less, preferably 0, when subjected to a standard shelf life test (25° C.) for up to 7 months.

### Methods for Making

The oxidatively stable comestible may be prepared by any method known to those of ordinary skill in the art, including those used to make EDTA-containing comestibles (e.g., EDTA-containing mayonnaise).

In some embodiments, the tannic acid is introduced along with other ingredients during the formation of the comestible base. The oxidatively stable comestible may be prepared under “post-acidified” conditions or under “pre-acidified” conditions.

An exemplary “post-acidified” procedure will now be described for preparation of a mayonnaise base. All aqueous phase components except for the acidulant may first be mixed or blended together. For example, the egg yolk (or egg yolk substitute), the tannic acid (preferably in the form of an aqueous solution), and any other optional aqueous phase ingredient (e.g., flavorants, preservatives, etc.) may be mixed or blended together, either manually, or using food processing machinery (e.g., STEPHEN UMC 5 universal machine, from Stephan Food Service Equipment GmbH) until a homogeneous mixture is obtained. The resulting “treated aqueous phase” (aqueous phase containing tannic acid) may have a pH of at least 5.5, preferably at least 5.7, preferably at least 6.0, preferably up to 6.2, preferably up to 6.4, and up to 7.5, preferably up to 7.3, preferably up to 7.0, preferably up to 6.8, preferably up to 6.6.

The method may next involve addition of the acidulant (e.g., vinegar) to form an acidified aqueous phase. The acidulant may be mixed with the treated aqueous phase by manual methods, or using food processing machinery. In some embodiments, the acidulant is added into the treated aqueous phase, which is then placed under vacuum and mixed together under reduced pressure using food process machinery, for example, at a pressure of less than or equal to 1 bar, preferably less than or equal to 0.8 bar, preferably less than or equal to 0.6 bar, preferably less than or equal to 0.4 bar.

Various mixing speeds may be employed ranging from manual mixing speeds to high speed mixing speeds, for example mixing speeds up to 10,000 rpm, preferably up to 7,000 rpm, preferably up to 5,000 rpm, preferably up to 3,000 rpm. In some embodiments, the acidified aqueous phase is mixed at a first mixing speed, for example, at least 500 rpm, preferably at least 750 rpm, preferably at least 1,000 rpm, preferably at least 1,250 rpm, preferably at least 1,500 rpm, and up to 1,750 rpm for up to 10 minutes, preferably up to 5 minutes, preferably up to 1 minute. In some embodiments, the acidified aqueous phase is mixed at a second mixing speed, for example, at least 1,800 rpm, preferably at least 2,000 rpm, preferably at least 2,200 rpm, and up to 2,500 rpm, preferably up to 2,400 rpm, preferably up to 2,300 rpm, preferably up to 2,250 rpm, for up to 10 minutes, preferably up to 5 minutes, preferably up to 1 minute.

In preferred embodiments, the acidified aqueous phase has a pH of at least 2.4, preferably at least 2.6, preferably at least 2.8, preferably at least 3.0, preferably at least 3.2, preferably at least 3.4, preferably at least 3.8, and up to 5.0, preferably up to 4.8, preferably up to 4.5, preferably up to 4.4, preferably up to 4.3, preferably up to 4.2, preferably up to 4.1, preferably up to 4.0, preferably up to 3.9.

The oil phase (i.e., the oil plus any other oily optional ingredients) may then be slowly added to the acidified aqueous phase, preferably while the acidified aqueous phase is in a dynamic (i.e., non-static) state, preferably under the second mixing speed conditions above. The oil phase may be slowly added manually or pumped/metered into the acidified aqueous phase automatically over the course of 5 minutes, preferably over the course of 3 minutes, preferably over the course of 1 minute, preferably over the course of 30 seconds, preferably over the course of 15 seconds.

Once the oil phase addition is completed, the mixing speed may be optionally increased to at least 2,600 rpm, preferably at least 2,700 rpm, preferably at least 2,800 rpm, and up to 3,500 rpm, preferably up to 3,300 rpm, preferably up to 3,000 rpm, and the mixture may be mixed for up to 10 minutes, preferably up to 5 minutes, preferably up to 1 minute, or until the oxidatively stable comestible is formed as a stable emulsion.

Alternatively, the oxidatively stable comestible may be prepared using a “pre-acidified” procedure, in which the order of addition of the acidulant and the tannic acid are swapped. By way of example, the egg yolk (or egg yolk substitute), the acidulant, and any other optional aqueous phase ingredient (e.g., flavorants, preservatives, etc.) may be mixed or blended together as described above to form an acidified aqueous phase as a homogeneous mixture. The tannic acid (preferably in the form of an aqueous solution) is then added to the acidified aqueous phase (under any of the conditions described above for the acidulant addition) to form a treated/acidified aqueous phase. Finally, the oil phase may be added as described above to form the oxidatively stable comestible as a stable emulsion.

It has been found that tannic acid has the highest capacity to chelate metal ions (e.g., Fe²⁺) under more neutral pH conditions, for example at a pH of 6 to 7, and loses some of its metal coordinating capacity under acidic conditions (e.g., a pH of 3 to 4). Therefore, the method of preparing the oxidatively stable comestible preferably involves the “post-acidified” procedure to allow tannic acid time to sequester metal ions in its most active state. When tannic acid is added to a pre-acidified aqueous solution (“pre-acidified” conditions), protection against oil oxidation is still afforded, though not to the same extent as when the oxidatively stable comestible is prepared according to the “post-acidified” procedure.

To prepare oxidatively stable comestibles which are mayonnaise-based but which typically include the presence of other ingredients such as is the case with ranch dressings, thousand island dressings, creamy Italian dressings, tartar sauces, fry sauces, Marie Rose sauces, rouille sauces, salsa golf sauces, sauce remoulades, and the like, the method may further involve mixing the mayonnaise base prepared above with one or more optional ingredients (e.g., a flavorant, a vegetable, a protein, a dairy product, a preservative, a thickening agent) to form the desired comestible. In one illustrative example, the mayonnaise base prepared as described above may be mixed with whole buttermilk, onions, garlic, parsley, iodized salt, thyme, xanthan gum, and black pepper, to form an oxidatively stable ranch dressing. The mixing may be performed using manual mixing techniques, such as using a whisk, or via food processing machinery.

Of course, various modifications to the above described methods are also contemplated. For example, the tannic acid may be introduced after the comestible base has been formed, i.e., a comestible base which has already been emulsified, for example, a pre-formed mayonnaise such as a commercial mayonnaise, may be treated with the tannic acid to form an oxidatively stable mayonnaise.

The examples below are intended to further illustrate the oxidatively stable comestibles, their properties, and their methods of manufacture, and are not intended to limit the scope of the claims.

### EXAMPLES

### Example 1

Mayonnaise samples were prepared in 400 g batches according to Association of Dressing and Sauce (ADS) guidelines and in terms of percentage (w/w) as shown in Table 1.

TABLE 1
Formulation of prepared mayonnaise

| Ingredient | Weight (%) | Weight (g) |
|---|---|---|
| Soybean oil | 76 | 304 |
| Salt | 2 | 8 |
| Mustard | 1 | 4 |
| Sugar | 2 | 8 |
| Egg yolk | 6 | 24 |
| Vinegar | 7.9 | 31.6 |
| Potassium sorbate | 0.05 | 0.2 |
| Sodium benzoate | 0.05 | 0.2 |
| Water/Antioxidant | 5 | 20 |
| solution | | |
| Total | 100% | 400 g |

In Table 1, the salt utilized was table salt (NaCl). The vinegar utilized was white distilled vinegar. The weight percent of the egg yolk was based on ‘wet’ basis.

The mayonnaise samples were prepared using a mayonnaise processing equipment (STEPHEN UMC 5 universal machine, from Stephan Food Service Equipment GmbH) according to the “post-acidified” procedure described below.

Water/Antioxidant solutions: Either water was used as a control (comparative), or a solution of an antioxidant (e.g., EDTA (comparative), gallic acid (comparative), or TANAL/ALSOK 04 (inventive)) were used, with the antioxidant being present in the antioxidant solution in varying concentrations. TANAL/ALSOK 04 is commercially available from Ajinomoto Bio-Pharma services.

The antioxidant solutions were prepared according to the following: Each batch was based on the 400 g final product of mayonnaise as shown in Table 1. Antioxidant solutions were prepared by dissolving an appropriate amount of antioxidant in 20 g deionized-water, for example 0.028 g EDTA (equal to 1,400 ppm stock solution) or 0.08 g TANAL/ALSOK 04 (equal to 4,000 ppm stock solution) in 20 g deionized-water provides a final antioxidant concentration of 70 ppm for EDTA or 200 ppm for TANAL/ALSOK 04 (ppm based on weight), respectively. The 70, 100, 150 ppm TANAL/ALSOK 04 treatment were implemented by the adjustment of the appropriate ratio of water to 4,000 ppm TANAL/ALSOK 04 stock solution at 13:7, 10:10, 5:15, respectively. Higher antioxidant loadings were prepared in a similar fashion using higher amounts of antioxidant, for example 0.2 g antioxidant in 20 g deionized-water equals 500 ppm antioxidant in the final mayonnaise (400 g).

### Post-Acidification Procedure

The soybean oil, salt, mustard, sugar, egg yolk, potassium sorbate, and sodium benzoate were added into the mixing bowl. Either water (control) or an antioxidant solution was then added, and blended well to make a homogeneous mix, followed by the addition of the vinegar.

The lid was tightly fitted and vacuum was pulled to 0.6 bars then the vacuum valve was closed. The ingredients were mixed together at a speed (50%) of 1500 rpm for 1 min and then at a speed (75%) of 2250 rpm for 1 min. The valve was opened a little bit and the soybean oil was pumped into the bowl automatically. At this stage, it was kept at a speed of 2250 rpm for 1 min and the oil valve was completely opened at this speed. Once all the oil was in, the mixer was switched to a speed of 3000 rpm (100%) for 1 min. The prepared mayonnaise was used for chemical and/or organoleptic testing.

### Testing

Samples were subjected to either a standard shelf life test (room temperature) or an accelerated shelf life test (40° C.) using the following procedure: Samples were distributed into 20 mL (72×20 mm) headspace vials (Chrompack) equipped with PTFE/silicone septa (in triplicate), in amounts of 5 g sample per 20 mL vial.
For standard shelf life tests, the sample vials were then capped, and allowed to sit in the dark at room temperature (23° C.±2° C.) for 13 weeks without stirring or mechanical agitation.
For accelerated shelf life tests, the sample vials were then capped and placed in an oven at 40° C. in the dark, and left in the oven for 8 weeks without stirring or mechanical agitation.

At the end of the shelf life time period, the samples were either:

a) cooled (in the case of accelerated shelf life tests), decapped, and flushed for approximately 6 seconds with a nitrogen stream at a flow rate of 500 ml/min to prevent further oxidation, re-capped, and subjected to a thiobarbituric acid-reactive substances (TBARS) assay, a peroxide value (PV) analysis, or an organoleptic color analysis; or

b) subjected to a volatile (headspace) analysis without removing the cap. Thiobarbituric acid-reactive substances (TBARS) analysis:

The thiobarbituric acid-reactive substances (TBARS) assay was performed as described by Buege, J. A. and Aust, S. D. “Microsomal lipid peroxidation” Methods Enzymol., 1978, 52, 302-310—incorporated herein by reference in its entirety. Briefly, 0.6 g sample was accurately measured into a 50 mL centrifuge tube. Then 0.6 mL pure water was added and mixed by vortex. Then 0.4 mL water/sample mixture was pipetted into a glass tube and mixed with 2 ml of a thiobarbituric acid (TBA) solution containing 0.375% thiobarbituric acid, 15% trichloroacetic acid, and 0.25 N HCl. The mixture was heated in boiling water with 50 rpm shaking for 10 min to develop a pink color, cooled with running tap water and then sonicated for 15 min followed by centrifugation at 5000 g at 25° C. for 5 min. 0.9 mL supernatant was pipetted into 48-well micro-plate. The absorbance of the supernatant was measured at 532 nm in Thermal Varioskan Lux micro-plate spectrometer. A standard curve was prepared using 1,1,3,3-tetramethoxypropane (malonaldehyde; MAD) at a concentration ranging from 0 to 300 ppm and TBARS was expressed as mg of MAD equivalents/kg sample×10. Higher TBARS values are indicative of higher levels of byproducts formed from lipid peroxidation.

### Peroxide Value (PV):

Peroxide value was determined according to the method of Sakanaka, Tachibana, Ishihara, and Raj Juneja “Antioxidant activity of egg-yolk protein hydrolysates in a linoleic acid oxidation system” Food chemistry, 2004, 86(1), 99-103—incorporated herein by reference in its entirety. Briefly, 0.6 g sample was accurately measured into a 50 mL centrifuge tube. Then 0.6 mL pure water was added and mixed by vortex. Then 0.2 mL water/sample mixture was pipetted into a new 50 mL centrifuge tube and mixed with 9.5 ml of 75% HPLC grade ethanol. 41 μL of 30% ammonium thiocyanate was firstly added into a glass tube, and then 2 mL sample/water/ethanol mixture was added into the glass tube for second step. Thirdly, 41 μl of 20 mM ferrous chloride solution in 3.5% HCl was added and mixed thoroughly. After 3 min, a pink color was shown, then the solution was centrifuged at 5000 g at 25° C. for 5 min. 0.9 mL supernatant was pipetted into 48-well micro-plate. The absorbance of the colored solution was measured at 500 nm using a Thermal Varioskan Lux micro-plate spectrometer. An increase in absorbance at 500 nm indicates increased formation of peroxide, i.e., higher degree of oxidation.

### Volatile (Headspace) Analysis:

The samples were subjected to volatile (headspace) analysis using a GC/MS (Agilent 7820A model equipped with a 5977B mass selective detector). The capped samples were placed in a water bath at 50° C. and allowed to equilibrate for 30 minutes to reach the maximum gas phase equilibrium. Then 1 mL of gas was taken out with a gas-tight syringe and directly injected into the GC/MS. A HP-5 MSD capillary column (30 m×250 μm×0.25 μm) was used, with helium as the carrier gas at 1.0 mL/min flow rate. The injector and the MS-transfer line were both maintained at 250° C. Oven temperature was held at 40° C. for 3 minutes, increased to 185° C. at 10° C./min, and finally further increased to 240° C. at 8° C./min (1 minute hold). The peak area of each volatile compound (hexanal, octanal, and nonanal oil oxidation products) was recorded and the changes were compared among different treatments. Higher values for hexanal, octanal, and nonanal are indicative of higher levels of oil oxidation.

### Organoleptic Color Analysis:

The samples were evaluated for color by trained panelists with experience in profiling and prescreened for their sensory acuity and given an organoleptic color score (0-7) according to the following color rating system in Table 2.

TABLE 2
Organoleptic (color) scoring system

| Color Score | Color category |
|---|---|
| 0 | White |
| 1 | Light Cream |
| 2 | Cream |
| 3 | Slight Dark Cream |
| 4 | Dark Cream |
| 5 | Light Brown |
| 6 | Medium Brown |
| 7 | Dark Brown |

Higher color scores are indicative of increased oil oxidation and/or higher contributions of the antioxidant to sample color. Samples with a score of 5 or above are generally considered to be of unacceptable color.

### Results

The results of the TBARS analysis, peroxide value (PV), volatile (headspace) analysis, and organoleptic color analysis for samples prepared by the post-acidification procedure and the standard shelf life test (room temperature) for 13 weeks are presented in Table 3. *Denotes comparative example.

TABLE 3
Standard shelf life tests of Mayonnaise samples

| | | Dosage | | | | | | Color |
|---|---|---|---|---|---|---|---|---|
| | Antioxidant | (ppm) | TBARS^{a)} | PV^{b}) | Hexanal^{c)} | Octanal^{c)} | Nananal^{c)} | Score |
| 1* | N/A | 0 | 265 | 2.3 | 15.3 | 5.5 | 1.7 | 0 |
| 2 | TANAL/ | 70 | 220 | 1.9 | 3.6 | 2.8 | 0.85 | 0 |
| | ALSOK 04 | | | | | | | |
| 3 | TANAL/ | 100 | 210 | 1.8 | 6 | 3.9 | 1.1 | 1 |
| | ALSOK 04 | | | | | | | |
| 4 | TANAL/ | 150 | 180 | 1.85 | 4 | 3.8 | 1.05 | 2 |
| | ALSOK 04 | | | | | | | |
| 5 | TANAL/ | 200 | 170 | 1.75 | 3.9 | 4.1 | 1 | 4 |
| | ALSOK 04 | | | | | | | |

^{a)}in units of mg MAD equivalents/kg sample × 10
^{b)}absorbance values at 500 nm
^{c)}Peak area

The results of the TBARS analysis, peroxide value (PV), and organoleptic color analysis for samples prepared by the post-acidification procedure and accelerated shelf life test (40° C.) for 8 weeks are presented in Table 4. *Denotes comparative example.

TABLE 4
Accelerated shelf life tests of Mayonnaise samples

| | Antioxidant | Dosage (ppm) | TBARS^{a)} | PV^{b)} | Color Score |
|---|---|---|---|---|---|
| 1* | N/A | 0 | 109 | 0.3 | 0 |
| 2 | TANAL/ | 100 | 102 | 0.26 | 1 |
| | ALSOK 04 | | | | |
| 3 | TANAL/ | 300 | 73 | 0.16 | 4 |
| | ALSOK 04 | | | | |
| 4 | TANAL/ | 500 | 64 | 0.08 | 5 |
| | ALSOK 04 | | | | |

^{a)}in units of mg MAD equivalents/kg sample × 10
^{b)}absorbance values at 500 nm

The results indicate that tannic acid effectively reduces oxidation, providing much lower TBARS values, PV values, and quantities of direct oxidation products (e.g., hexanal, octanal, and nonanal peak areas), even when dosed at low (70 ppm) levels, though it is increasingly more effective with increasing concentrations (Table 3—samples 2 to 5, Table 4—samples 2 to 4). While the color of the mayonnaise does seem to be affected by the addition of tannic acid in dosages above 70 ppm, the color change doesn't rise to unacceptable levels when stored at room temperature, particularly when used in products having higher color profiles than mayonnaise.

Mayonnaise samples prepared using 70 to 500 ppm of gallic acid (not shown) were difficult to prepare due to the insolubility of gallic acid in water. Even when successfully prepared, such gallic acid treated mayonnaise samples had an unacceptable astringent and sour character throughout the standard shelf life test. Therefore, gallic acid was deemed to be an inferior antioxidant.

### Example 2

Mayonnaise samples were prepared according to Example 1 (see for example Table 1), except that the mayonnaise samples were prepared according to the “pre-acidified” procedure described below.

### Pre-Acidification Procedure

The soybean oil, salt, mustard, sugar, egg yolk, potassium sorbate, and sodium benzoate were added into the mixing bowl. Vinegar was then added, and blended well to make a homogeneous mix, followed by the addition of either water (control) or an antioxidant solution.

The lid was tightly fitted and vacuum was pulled to 0.6 bars then the vacuum valve was closed. The ingredients were mixed together at a speed (50%) of 1500 rpm for 1 min and then at a speed (75%) of 2250 rpm for 1 min. The valve was opened a little bit and the soybean oil was pumped into the bowl automatically. At this stage, it was kept at a speed of 2250 rpm for 1 min and the oil valve was completely opened at this speed. Once all the oil was in, the mixer was switched to a speed of 3000 rpm (100%) for 1 min. The prepared mayonnaise was used for chemical and/or organoleptic testing.

### Testing

Samples were subjected to the accelerated shelf life test (40° C.) described in Example 1 and then subjected to the thiobarbituric acid-reactive substances (TBARS) assay as described in Example 1.

### Results

The results of the TBARS analysis from mayonnaise samples obtained from the pre-acidification procedure (Example 2) were compared to those obtained from the post-acidification procedure (Example 1), as shown in Table 5 below.

TABLE 5
Accelerated shelf life/TBARS tests of Mayonnaise samples

| | | | Post- | Pre- | |
|---|---|---|---|---|---|
| | | Dosage | acidification | acidification | |
| | Antioxidant | (ppm) | (Example 1)^{a)} | (Example 2)^{a)} | Significant |
| 1* | N/A | 0 | 109 | 109 | N |
| 2 | TANAL/ | 100 | 102 | 97 | N |
| | ALSOK 04 | | | | |
| 3 | TANAL/ | 300 | 73 | 89 | Y |
| | ALSOK 04 | | | | |
| 4 | TANAL/ | 500 | 64 | 77 | Y |
| | ALSOK 04 | | | | |

^{a)}in units of mg MAD equivalents/kg sample × 10

The results demonstrate that mayonnaise samples prepared without tannic acid (comparative sample 1) suffer from the same level of oxidation/breakdown regardless of whether a pre- or post-acidification procedure is employed. On the other hand, the results from Table 5 demonstrate that the most effective use of tannic acid is when acidification is implemented after tannic acid treatment (post-acidification procedure), with significant differences in oxidation levels occurring in samples containing 300 ppm levels or higher of tannic acid (samples 3 and 4).

It has been found that tannic acid has the highest ability to chelate metal ions (e.g., Fe²⁺) at neutral pH (˜6.85) but loses this ability when in acidic conditions (˜pH 3.8). Therefore, if tannic acid is added to the aqueous phase which has been pre-acidified, the addition of tannic acid affords a certain level of protection against oil oxidation, though not to the same extent as when tannic acid is added under neutral conditions followed by acidification.

### Example 3

Ranch dressing samples were prepared using the mayonnaise base according to Example 1 (using the w/w percentages in Table 1) and according to the Association of Dressing and Sauce (ADS) guidelines in terms of percentage (w/w) as shown in Table 6.

TABLE 6
Ranch dressing formulation

| Ingredient | Weight (%) | Weight (g) |
|---|---|---|
| Mayonnaise (as prepared from | 66.1 | 2,800 |
| Example 1) | | |
| Whole milk buttermilk | 29.7 | 1,258 |
| Dried chopped onions | 3.7 | 158 |
| Minced garlic | 0.3 | 13 |
| Dried parsley flakes | 0.09 | 3.5 |
| Iodized salt | 0.04 | 1.5 |
| Dried ground thyme | 0.03 | 1.2 |
| Xanthan gum | 0.02 | 1.0 |
| Ground black pepper | 0.02 | 0.75 |
| Total | 100% | 4236.95 g |

To prepare the ranch dressing samples, all ingredients were dispensed in a stainless steel mixing bowl and mixed by equipment with a whisk to achieve a uniform consistency. The dressing was held at room temperature for 30 to 60 min to allow the pH to stabilize. To prepare ranch dressing samples having different loadings of tannic acid, various mayonnaise samples having different concentrations of tannic acid were employed.

### Testing

Samples were subjected to a standard shelf life test (25° C.) by placing the samples into 20 mL (72×20 mm) headspace vials (Chrompack) equipped with PTFE/silicone septa, in amounts of 5 g sample per 20 mL vial. The sample vials were then capped, and allowed to sit in the dark at (25° C.) for up to 7 months. Samples were removed at various 1 month time intervals (1 month, 2 months, 3 months, 4 months, 5 months, 6 months, and 7 months) for organoleptic testing. At the end of a samples shelf life time period, the sample was decapped, and flushed for approximately 6 seconds with a nitrogen stream at a flow rate of 500 ml/min to prevent further oxidation. The sample was then re-capped and subjected to an organoleptic flavor analysis or an organoleptic color analysis discussed below.

### Organoleptic Flavor Analysis:

The samples were evaluated for flavor by trained panelists with experience in profiling and prescreened for their sensory acuity and given an organoleptic flavor score (0-7) according to the development of painty (indicative of oxidation) and/or chemical flavors (indicative of adverse flavor contributions from the antioxidant). Each sample score was averaged and rounded to the nearest quarter fraction.

A score of 7 indicates very little, or no painty/chemical flavors, while a score of 0 indicates very intense flavor associated with oxidation and/or antioxidant chemical tastes. Samples with a score of 4 or below are generally considered to be inedible.

### Organoleptic Color Analysis:

The samples were evaluated for color according to the procedure in Example 1 (Table 2).

### Results

The results of the organoleptic flavor analysis are presented in Table 7. *Denotes comparative example.

TABLE 7
Organoleptic flavor score (0-7) of ranch dressing
samples (standard shelf life test)

| | | Dosage | Month | | | | | | |
|---|---|---|---|---|---|---|---|---|---|
| | Antioxidant | (ppm) | 1 | 2 | 3 | 4 | 5 | 6 | 7 |
| 1* | N/A | 0 | 6.5 | 6.25 | 5.5 | 5 | 4 | 3.5 | 3 |
| 2 | TANAL/ | 250 | 6.75 | 6.5 | 5.75 | 5.5 | 5 | 4.5 | 4.5 |
| | ALSOK 04 | | | | | | | | |
| 3 | TANAL/ | 500 | 7 | 6.5 | 6.25 | 6 | 5.5 | 5 | 5 |
| | ALSOK 04 | | | | | | | | |
| 4 | TANAL/ | 750 | 7 | 7 | 6.5 | 6 | 5 | 4.5 | 3.75 |
| | ALSOK 04 | | | | | | | | |

All samples treated with tannic acid (samples 2-4) performed better than untreated ranch dressing (sample 1). The untreated ranch dressing (sample 1) became very painty and inedible by month 5 and became progressively worse each month thereafter. Samples prepared with 250 and 500 ppm of tannic acid (samples 2 and 3, respectively) both performed well to reduce oxidative (painty) flavors while also not adversely affecting the taste with chemical flavors.

The sample prepared with 750 ppm tannic acid (sample 4) started off well, but began developing chemical flavors (not oxidative) by month 5 and strong chemical flavors by month 7. While such strong chemical flavors at month 7 may be unacceptable in ranch (or mayonnaise) dressing, it may be acceptable in a more full flavored product, especially when one considers that the 750 ppm tannic acid dosage effectively prevents the rancid/painty flavors stemming from oxidation.

The results of the organoleptic color analysis are presented in Table 8. *Denotes comparative example.

TABLE 8
Organoleptic color score (0-7) of ranch dressing
samples (standard shelf life test)

| | | Dosage | Month | | | | | | |
|---|---|---|---|---|---|---|---|---|---|
| | Antioxidant | (ppm) | 1 | 2 | 3 | 4 | 5 | 6 | 7 |
| 1* | N/A | 0 | 1 | 1 | 1 | 1 | 1 | 2 | 2 |
| 2 | TANAL/ | 250 | 1 | 1 | 2 | 2 | 2 | 2 | 3 |
| | ALSOK 04 | | | | | | | | |
| 3 | TANAL/ | 500 | 2 | 2 | 2 | 2 | 3 | 3 | 4 |
| | ALSOK 04 | | | | | | | | |
| 4 | TANAL/ | 750 | 2 | 2 | 3 | 3 | 4 | 5 | 6 |
| | ALSOK 04 | | | | | | | | |

The untreated ranch sample (sample 1) retained color the best of all tested samples. While the color of the ranch dressing does seem to be affected by the addition of tannic acid, the samples prepared with 250 and 500 ppm of tannic acid (samples 2 and 3, respectively) only darkened to a certain degree, and not to a level that is considered unacceptable. Sample 4, prepared with 750 ppm of tannic acid, started off slightly darker than the other samples, and became progressively darker and unacceptable over the time of the study. Still, the higher tannic acid loadings (e.g., 750 ppm) may still be useful in products having higher color profiles than mayonnaise and ranch dressings.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. An oxidatively stable comestible, comprising:
a comestible base comprising an oil and an acidulant; and
tannic acid blended into the comestible base;
wherein the tannic acid is present in an amount up to 750 ppm, based on a total weight of the oxidatively stable comestible.

2. The oxidatively stable comestible of claim 1, wherein the tannic acid is present in an amount of 70 to 500 ppm, based on a total weight of the oxidatively stable comestible.

3. The oxidatively stable comestible of claim 1, wherein the tannic acid is present in an amount of 100 to 450 ppm, based on a total weight of the oxidatively stable comestible.

4. The oxidatively stable comestible of claim 1, wherein the tannic acid blended into the comestible base is a purified form of tannic acid having a tannic acid content of at least 90 wt %.

5. The oxidatively stable comestible of claim 1, wherein tannic acid is a polygalloyl glucose.

6. The oxidatively stable comestible of claim 1, wherein the tannic acid is a polygalloyl quinic acid ester.

7. The oxidatively stable comestible of claim 1, wherein tannic acid is a polygalloyl glucose having a weight average molecular weight of 1,260 to 1,600 g/mol, a polygalloyl glucose having a weight average molecular weight of 975 to 1,200 g/mol, or a polygalloyl quinic acid ester having a weight average molecular weight of 750 to 945 g/mol.

8. The oxidatively stable comestible of claim 1, which is substantially free of a phenolic acid.

9. The oxidatively stable comestible of claim 1, which is substantially free of gallic acid.

10. The oxidatively stable comestible of claim 1, which is substantially free of ethylene diamine tetraacetic acid.

11. The oxidatively stable comestible of claim 1, wherein the comestible base is a stable water-continuous emulsion.

12. The oxidatively stable comestible of claim 1, which is a dressing, a sauce, a dip, and/or a spread.

13. The oxidatively stable comestible of claim 10, which is a mayonnaise, a ranch dressing, a thousand island dressing, a creamy Italian dressing, a tartar sauce, or an aioli.

14. The oxidatively stable comestible of claim 1, wherein the oil is at least one selected from the group consisting of olive oil, vegetable oil, canola oil, soybean oil, corn oil, peanut oil, sunflower oil, sesame oil, coconut oil, and palm oil.

15. The oxidatively stable comestible of claim 1, wherein the acidulant is a vinegar, a citrus juice, or both.

16. The oxidatively stable comestible of claim 1, wherein the comestible base further comprises an egg yolk or an egg yolk substitute.

17. The oxidatively stable comestible of claim 1, wherein the comestible base further comprises at least one selected from the group consisting of a flavorant, a vegetable, a protein, a dairy product, a preservative, and a thickening agent.

18. A method of preparing an oxidatively stable comestible comprising a) a comestible base comprising an oil, an acidulant, and an egg yolk or an egg yolk substitute, and b) tannic acid blended into the comestible base, wherein the tannic acid is present in an amount up to 750 ppm, based on a total weight of the oxidatively stable comestible, the method comprising:
blending the tannic acid into an aqueous phase comprising the egg yolk or the egg yolk substitute to form a treated aqueous phase;
adding the acidulant to the treated aqueous phase to form an acidified aqueous phase; and
adding an oil phase comprising the oil into the acidified aqueous phase and blending.

19. The method of claim 18, wherein the treated aqueous phase has a pH of 5.5 to 7.5 and the acidified aqueous phase has a pH of 2.4 to 4.5.

20. The method of claim 18, further comprising adding at least one selected from the group consisting of a flavorant, a vegetable, a protein, a dairy product, a preservative, and a thickening agent.

21. The method of claim 20, wherein the oxidatively stable comestible is a mayonnaise, a ranch dressing, a thousand island dressing, a creamy Italian dressing, a tartar sauce, or an aioli.
